(19) United States
(12) Patent Application Publication
(10) Pub. No.: US 2024/0120619 A1
(43) Pub. Date: Apr. 11, 2024

(54) POWER STORAGE MODULE

(71) Applicant: TOYOTA JIDOSHA KABUSHIKI KAISHA, Toyota-shi (JP)

(72) Inventors: Shingo KOMURA, Nagakute-shi (JP); Yusuke YAMASHITA, Kariya-shi (JP)

(73) Assignee: TOYOTA JIDOSHA KABUSHIKI KAISHA, Toyota-shi (JP)

(21) Appl. No.: 18/472,635

(22) Filed: Sep. 22, 2023

(30) Foreign Application Priority Data
Oct. 6, 2022 (JP) 2022-161896

(51) Int. Cl. H01M 50/463; H01M 4/02; H01M 10/04; H01M 50/186; H01M 50/46; H01M 50/586; H01M 50/593

(52) U.S. Cl. CPC H01M 50/463; H01M 4/02; H01M 10/04; H01M 50/186; H01M 50/46; H01M 50/586; H01M 50/593; H01M 2004/027; H01M 2004/028; H01M 2004/029

(57) ABSTRACT

A power storage module comprises a plurality of bipolar electrodes, an outermost positive electrode, an outermost negative electrode, a first sealing part, a second sealing part, an inner sealing part, a first insulating member, a second insulating member, and an inner insulating member. At a periphery of each positive electrode current-collecting foil, a positive-electrode-free portion is formed, and at a periphery of each negative electrode current-collecting foil, a negative-electrode-free portion is formed. The first insulating member includes a first outer insulating part, the second insulating member includes a second outer insulating part, and the inner insulating member includes an inner insulating part. Each of a thickness of the first outer insulating part and a thickness of the second outer insulating part is more than a thickness of the inner insulating part.

### CROSS REFERENCE TO RELATED APPLICATIONS

This nonprovisional application is based on Japanese Patent Application No. 2022-161896 filed on Oct. 6, 2022, with the Japan Patent Office, the entire contents of which are hereby incorporated by reference.

### BACKGROUND

### Field

The present disclosure relates to a power storage module.

### Description of the Background Art

Japanese Patent Laying-Open No. 2021-128898 discloses a power storage module comprising: a plurality of bipolar electrodes; a plurality of separators interposed between the bipolar electrodes adjacent to each other; a sealing part sealing space between the bipolar electrodes adjacent to each other; and an electrolyte solution located in the space. Each separator has an overlapping portion that overlaps an electrode layer of the bipolar electrode when viewed in a stacking direction, and also has an exposed portion that does not overlap the electrode layer. The region at which the exposed portion is present functions to hold gas that is produced during charging and discharging.

### SUMMARY

As for the power storage module disclosed by Japanese Patent Laying-Open No. 2021-128898, the pressure inside the power storage module can sometimes be reduced to below atmospheric pressure, and, in this case, due to the pressure difference between inside and outside the power storage module, the electrode that is located outermost in the stacking direction can deform inwardly. If there is a foreign object, such as a piece of metal, present on this deformable region of the outermost electrode, namely a region where the exposed portion of the separator is present, the foreign object can penetrate through the separator, possibly causing a contact between a pair of electrodes that flank the exposed portion.

In order to avoid such a short circuit, the thickness of each separator can be increased. However, this would result in a decrease of the volume of the region, which is located within the region where the exposed portion is present, that is capable of holding gas produced during charging and discharging, and, thereby, when the pressure at this region increases, the sealing part can break. In order to avoid a pressure increase at this region, the area of the electrode layer can be decreased; however, this can cause a decrease of energy density.

An object of the present disclosure is to provide a power storage module that is capable of reducing a decrease of energy density and breakage of a sealing part, and also capable of inhibiting a short circuit from occurring when the inner pressure is reduced to below atmospheric pressure.

A power storage module according to an aspect of the present disclosure comprises: a plurality of bipolar electrodes stacked on top of one another; an outermost positive electrode located on one outer side of a set of the plurality of bipolar electrodes in a stacking direction of the plurality of bipolar electrodes; an outermost negative electrode located on the other outer side of the set of the plurality of bipolar electrodes in the stacking direction; a first sealing part that seals a first outer region in a state where pressure of the first outer region is below atmospheric pressure, the first outer region being formed between the outermost positive electrode and a bipolar electrode among the plurality of bipolar electrodes facing the outermost positive electrode; a second sealing part that seals a second outer region in a state where pressure of the second outer region is below atmospheric pressure, the second outer region being formed between the outermost negative electrode and a bipolar electrode among the plurality of bipolar electrodes facing the outermost negative electrode; an inner sealing part that seals an inner region in a state where pressure of the inner region is below atmospheric pressure, the inner region being formed between a pair of the bipolar electrodes that are adjacent to each other in the stacking direction; a first insulating member that insulates the outermost positive electrode from the bipolar electrode among the plurality of bipolar electrodes facing the outermost positive electrode; a second insulating member that insulates the outermost negative electrode from the bipolar electrode among the plurality of bipolar electrodes facing the outermost negative electrode; and an inner insulating member that insulates a pair of the bipolar electrodes that are adjacent to each other in the stacking direction, from one another, where each of the plurality of bipolar electrodes has: a current collector including a positive electrode current-collecting foil and a negative electrode current-collecting foil; a positive electrode active material layer provided on the positive electrode current-collecting foil of the current collector; and a negative electrode active material layer provided on the negative electrode current-collecting foil of the current collector, the outermost positive electrode has: a positive electrode current-collecting foil; and a positive electrode active material layer provided on the positive electrode current-collecting foil, the outermost negative electrode has: a negative electrode current-collecting foil; and a negative electrode active material layer provided on the negative electrode current-collecting foil, at each of a periphery of the positive electrode current-collecting foil of the current collector and a periphery of the positive electrode current-collecting foil of the outermost positive electrode, a positive-electrode-free portion that is not covered with the positive electrode active material layer is formed, at each of a periphery of the negative electrode current-collecting foil of the current collector and a periphery of the negative electrode current-collecting foil of the outermost negative electrode, a negative-electrode-free portion that faces the positive-electrode-free portion in the stacking direction and that is not covered with the negative electrode active material layer is formed, a region between the positive-electrode-free portion of the outermost positive electrode and the negative-electrode-free portion facing the positive-electrode-free portion constitutes the first outer region, a region between the negative-electrode-free portion of the outermost negative electrode and the positive-electrode-free portion facing the negative-electrode-free portion constitutes the second outer region, a region between a pair of the bipolar electrodes that are adjacent to each other, specifically between the positive-electrode-free portion and the negative-electrode-free portion facing each other in the stacking direction, constitutes the inner region, the first insulating member includes a first outer insulating part located in the first outer region, the second insulating member includes a second outer insulating part located in the second outer region, the inner insulating member includes an inner insulating part located in the inner region, and each of a thickness of the first outer insulating part and a thickness of the second outer insulating part is more than a thickness of the inner insulating part.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view schematically illustrating a power storage module according to First Embodiment of the present disclosure.

FIG. 2 is a cross-sectional view schematically illustrating a state where the regions are under reduced pressure.

FIG. 3 is a cross-sectional view schematically illustrating a power storage module according to Second Embodiment of the present disclosure.

FIG. 4 is a table showing Examples, Comparative Examples, and evaluation results.

### DESCRIPTION OF THE PREFERRED EMBODIMENTS

A description will be given of embodiments of the present disclosure, with reference to drawings. In the drawings referenced below, the same or equivalent members are denoted by the same numeral.

### First Embodiment

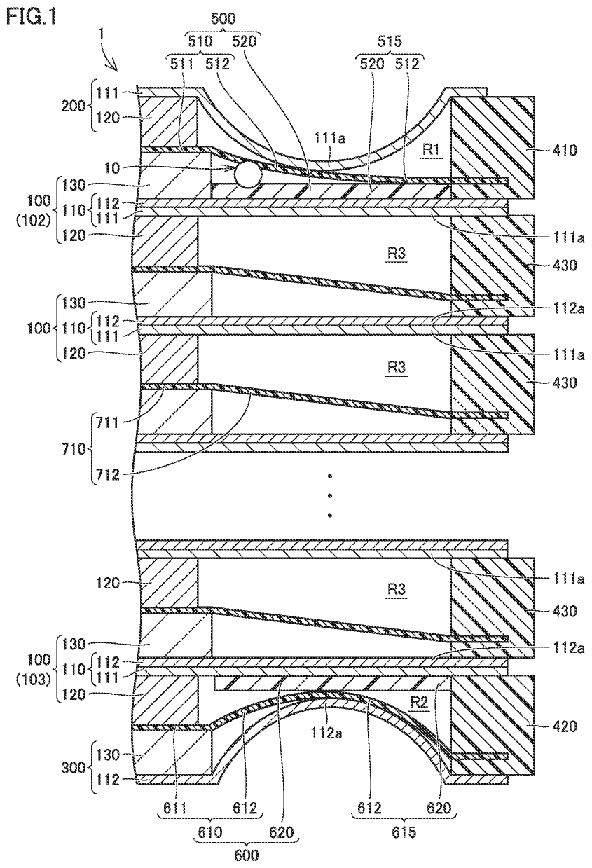

FIG. 1 is a cross-sectional view schematically illustrating a power storage module according to First Embodiment of the present disclosure. As illustrated in FIG. 1, a power storage module 1 comprises a plurality of bipolar electrodes 100, an outermost positive electrode 200, an outermost negative electrode 300, a first sealing part 410, a second sealing part 420, an inner sealing part 430, a first insulating member 500, a second insulating member 600, and an inner insulating member 710.

Bipolar electrodes 100 are stacked on top of one another. Each bipolar electrode 100 has a current collector 110, a positive electrode active material layer 120, and a negative electrode active material layer 130.

Current collector 110 is made of metal and, for example, has a rectangular shape. Current collector 110 has a positive electrode current-collecting foil 111 and a negative electrode current-collecting foil 112. Positive electrode current-collecting foil 111 is made of aluminum, for example. Negative electrode current-collecting foil 112 is made of copper foil, for example. Negative electrode current-collecting foil 112 is adhered to positive electrode current-collecting foil 111 by means of an electrically-conductive adhesive.

Positive electrode active material layer 120 is provided at one side of current collector 110, namely, on a surface of positive electrode current-collecting foil 111. Negative electrode active material layer 130 is provided at the other side of current collector 110, namely, on a surface of negative electrode current-collecting foil 112.

Bipolar electrodes 100 are stacked so that positive electrode active material layer 120 of one bipolar electrode 100 faces negative electrode active material layer 130 of another bipolar electrode 100 that is adjacent to the one bipolar electrode 100.

At a periphery of positive electrode current-collecting foil 111, a positive-electrode-free portion 111a that is not covered with positive electrode active material layer 120 is formed. At a periphery of negative electrode active material layer 130, a negative-electrode-free portion 112a that is not covered with negative electrode active material layer 130 is formed. Negative-electrode-free portion 112a faces positive-electrode-free portion 111a in the stacking direction of bipolar electrodes 100 (the vertical direction in FIG. 1).

Outermost positive electrode 200 is located on one outer side of a set of bipolar electrodes 100 in the stacking direction. Outermost positive electrode 200 has a positive electrode current-collecting foil 111, and a positive electrode active material layer 120 provided on positive electrode current-collecting foil 111. The configuration of positive electrode current-collecting foil 111 and positive electrode active material layer 120 in outermost positive electrode 200 is the same as that in bipolar electrode 100.

Outermost negative electrode 300 is located on the other outer side of the set of bipolar electrodes 100 in the stacking direction. Outermost negative electrode 300 has a negative electrode current-collecting foil 112, and a negative electrode active material layer 130 provided on negative electrode current-collecting foil 112. The configuration of negative electrode current-collecting foil 112 and negative electrode active material layer 130 in outermost negative electrode 300 is the same as that in bipolar electrode 100.

First sealing part 410 seals a first outer region R1 in a state where pressure of first outer region R1 is below atmospheric pressure, where first outer region R1 is formed between outermost positive electrode 200 and a bipolar electrode 100 among bipolar electrodes 100 facing outermost positive electrode 200 (hereinafter expressed as “a bipolar electrode 102”) (see FIG. 1). First outer region R1 is a region that is formed between positive-electrode-free portion 111a of outermost positive electrode 200 and negative-electrode-free portion 112a facing this positive-electrode-free portion 111a. First outer region R1 is filled with an electrolyte solution. Because the pressure of first outer region R1 is below atmospheric pressure, positive-electrode-free portion 111a of outermost positive electrode 200 is deformed inwardly in the stacking direction as seen in FIG. 1.

First sealing part 410 is made of an insulating material (such as resin). First sealing part 410 has a function of preventing leakage of the electrolyte solution from first outer region R1 and penetration of moisture from outside into first outer region R1, and also a function of maintaining the space between positive-electrode-free portion 111a and negative-electrode-free portion 112a flanking first outer region R1.

Second sealing part 420 seals a second outer region R2 in a state where pressure of second outer region R2 is below atmospheric pressure, where second outer region R2 is formed between outermost negative electrode 300 and a bipolar electrode 100 among bipolar electrodes 100 facing outermost negative electrode 300 (hereinafter expressed as “a bipolar electrode 103”) (see FIG. 1). Second outer region R2 is a region that is formed between negative-electrode-free portion 112a of outermost negative electrode 300 and positive-electrode-free portion 111a facing this negative-electrode-free portion 112a. Second outer region R2 is filled with an electrolyte solution. The pressure of second outer region R2 is the same as the pressure of first outer region R1. Because the pressure of second outer region R2 is below atmospheric pressure, negative-electrode-free portion 112a of outermost negative electrode 300 is deformed inwardly in the stacking direction as seen in FIG. 1. The configuration of second sealing part 420 is the same as that of first sealing part 410.

Inner sealing part 430 seals an inner region R3 in a state where pressure of inner region R3 is below atmospheric pressure, where inner region R3 is formed between a pair of bipolar electrodes 100 that are adjacent to each other in the stacking direction (see FIG. 1). Inner region R3 is a region between a pair of bipolar electrodes 100 that are adjacent to each other, specifically between positive-electrode-free portion 111a and negative-electrode-free portion 112a facing each other in the stacking direction. Inner region R3 is filled with an electrolyte solution. The configuration of inner sealing part 430 is the same as that of first sealing part 410. The pressure of inner region R3 is the same as the pressure of first outer region R1.

First insulating member 500 insulates outermost positive electrode 200 from bipolar electrode 102. First insulating member 500 has a first separator 510 and a first insulating film 520.

First separator 510 is interposed between outermost positive electrode 200 and bipolar electrode 102. First separator 510 is made of an insulating material and allows ions to pass through itself. Examples of first separator 510 include a microporous polyolefin film (having a polyethylene monolayer structure and/or a polypropylene/polyethylene/polypropylene three-layer structure, for example). On at least one side of the microporous polyolefin film, a ceramic layer may be provided. First separator 510 has a first interposed part 511 and a first peripheral part 512.

First interposed part 511 is interposed between positive electrode active material layer 120 of outermost positive electrode 200 and negative electrode active material layer 130 of bipolar electrode 102.

First peripheral part 512 is connected with an outer edge of first interposed part 511. First peripheral part 512 is located in first outer region R1. An outer end of first peripheral part 512 is supported by first sealing part 410. As illustrated in FIG. 1, first peripheral part 512 is pushed by positive-electrode-free portion 111a, which is deformed inwardly in the stacking direction, and thereby deformed inwardly in the stacking direction.

First insulating film 520 is a separate member from first separator 510. First insulating film 520 is located in first outer region R1. The thickness of first insulating film 520 is designed to be equal to or larger than the thickness of first separator 510, for example. First insulating film 520 is preferably located in first outer region R1 and on the inside of first peripheral part 512 in the stacking direction. In FIG. 1, a foreign object 10 such as a piece of metal is seen between first peripheral part 512 and first insulating film 520.

First peripheral part 512 and first insulating film 520 constitute a first outer insulating part 515, which is located in first outer region R1. First outer insulating part 515 insulates positive-electrode-free portion 111a from negative-electrode-free portion 112a, the latter two flanking first outer region R1.

Second insulating member 600 insulates outermost negative electrode 300 from bipolar electrode 103. Second insulating member 600 has a second separator 610 and a second insulating film 620.

Second separator 610 is interposed between outermost negative electrode 300 and bipolar electrode 103. The configuration of second separator 610 is the same as the configuration of first separator 510. That is, the thickness of second separator 610 is the same as the thickness of first separator 510. Second separator 610 has a second interposed part 611 and a second peripheral part 612.

Second interposed part 611 is interposed between negative electrode active material layer 130 of outermost negative electrode 300 and positive electrode active material layer 120 of bipolar electrode 103.

Second peripheral part 612 is connected with an outer edge of second interposed part 611. Second peripheral part 612 is located in second outer region R2. An outer end of second peripheral part 612 is supported by second sealing part 420. As seen in FIG. 1, second peripheral part 612 is pushed by negative-electrode-free portion 112a, which is deformed inwardly in the stacking direction, and thereby deformed inwardly in the stacking direction.

Second insulating film 620 is a separate member from second separator 610. Second insulating film 620 is located in second outer region R2. The configuration of second insulating film 620 is the same as the configuration of first insulating film 520. Second insulating film 620 is preferably located in second outer region R2 and on the inside of second peripheral part 612 in the stacking direction.

Second peripheral part 612 and second insulating film 620 constitute a second outer insulating part 615, which is located in second outer region R2. Second outer insulating part 615 insulates positive-electrode-free portion 111a from negative-electrode-free portion 112a, the latter two flanking second outer region R2.

Inner insulating member 710 insulates a pair of bipolar electrodes 100 that are adjacent to each other in the stacking direction, from each other. Inner insulating member 710 is constituted of an inner separator (hereinafter expressed as “an inner separator 710”) that is interposed between a pair of bipolar electrodes 100 that are adjacent to each other in the stacking direction. Inner separator 710 has the same thickness as first separator 510. Inner separator 710 has an inner interposed part 711 and an inner peripheral part 712.

Inner interposed part 711 is interposed between positive electrode active material layer 120 of one bipolar electrode 100 and negative electrode active material layer 130 of another bipolar electrode 100 that is adjacent to the one bipolar electrode 100.

Inner peripheral part 712 is connected with inner interposed part 711. Inner peripheral part 712 is located in inner region R3. Inner peripheral part 712 constitutes an inner insulating part (which may also be expressed as “an inner insulating part 712” hereinafter).

As illustrated in FIG. 1, each of the thickness of first outer insulating part 515 and the thickness of second outer insulating part 615 is more than the thickness of inner insulating part 712. Herein, the “thickness of first outer insulating part 515” means the total thickness of first outer insulating part 515, more specifically, the sum of the thickness of first peripheral part 512 and the thickness of first insulating film 520. The same applies to the “thickness of second outer insulating part 615”.

Next, a method of producing power storage module 1 will be described.

Firstly, bipolar electrodes 100, outermost positive electrode 200, and outermost negative electrode 300 are prepared, which are then stacked on top of one another with separators 510, 610, 710 interposed therebetween, and first insulating film 520 is positioned in first outer region R1 and second insulating film 620 is positioned in second outer region R2.

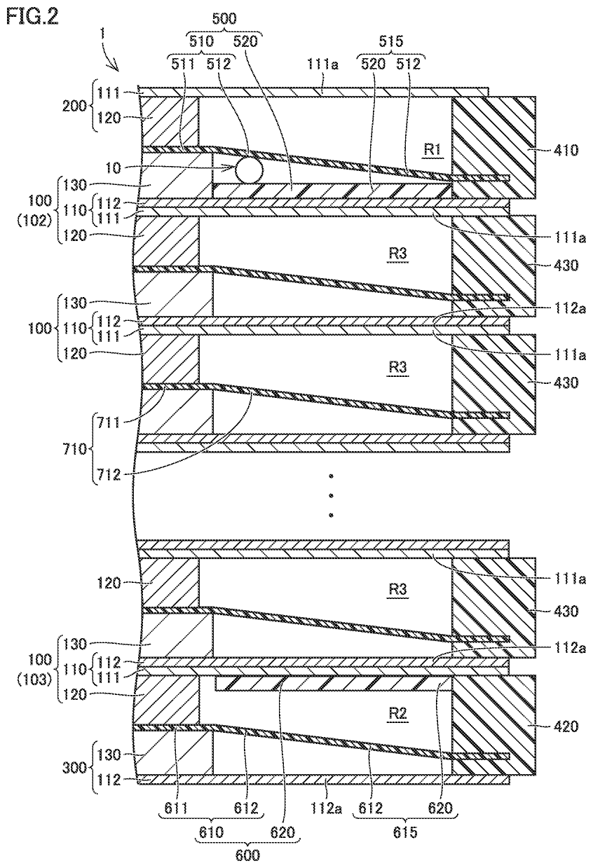

Then, sealing parts 410 to 430 are heat-sealed to positive-electrode-free portion 111a and to negative-electrode-free portion 112a, and, through a liquid inlet, an electrolyte solution is injected into each of regions R1 to R3. FIG. 2 illustrates a state where the electrolyte solution has already been injected in each of regions R1 to R3, for example.

Then, power storage module 1 is charged to a certain voltage, and an SEI film is formed on the negative electrode due to degradation of the solvent of the electrolyte solution and additives, accompanied by a by-product gas discharged out of power storage module 1.

Subsequently, in an atmosphere under reduced pressure (an atmosphere where the pressure is below atmospheric pressure), the liquid inlet is sealed (a reduced-pressure sealing step). Thus, power storage module 1 is completed. When this power storage module 1 is moved from the reduced-pressure atmosphere to an atmosphere under atmospheric pressure, positive-electrode-free portion 111a of outermost positive electrode 200 and negative-electrode-free portion 112a of outermost negative electrode 300 are deformed inwardly in the stacking direction, as seen in FIG. 1.

As described above, in power storage module 1 according to the present embodiment, positive-electrode-free portion 111a of outermost positive electrode 200 and negative-electrode-free portion 112a of outermost negative electrode 300 deform inwardly in the stacking direction due to the low pressure of first outer region R1, second outer region R2, and inner region R3 below atmospheric pressure, but because each of the thickness of first outer insulating part 515 and the thickness of second outer insulating part 615 is more than the thickness of inner insulating part 712, foreign object 10 such as a piece of metal, if it is present, in first outer region R1, for example, is inhibited from penetrating through first outer insulating part 515.

In addition, because the thickness of inner insulating part 712 is less than each of the thickness of first outer insulating part 515 and the thickness of second outer insulating part 615, inner region R3 has enough space for holding gas that is produced during charging and discharging and, thereby, the pressure of inner region R3 is less likely to become high. This reduces breakage of inner sealing part 430, and it also decreases the necessity for enlarging electrode-free portions 111a, 112a in bipolar electrode 100 in an attempt to prevent the pressure of inner region R3 from rising too high, resulting in mitigating a decrease of energy density.

In the above-mentioned embodiment, first insulating film 520 may be made of the same material as a material of first sealing part 410 and integrally formed with first sealing part 410, and second insulating film 620 may be made of the same material as a material of second sealing part 420 and integrally formed with second sealing part 420. In this aspect, displacement of first insulating film 520 within first outer region R1 and displacement of second insulating film 620 within second outer region R2 are reduced.

Moreover, first insulating film 520 may be located on the outside of first peripheral part 512 in the stacking direction, and second insulating film 620 may be located on the outside of second peripheral part 612 in the stacking direction.

### Second Embodiment

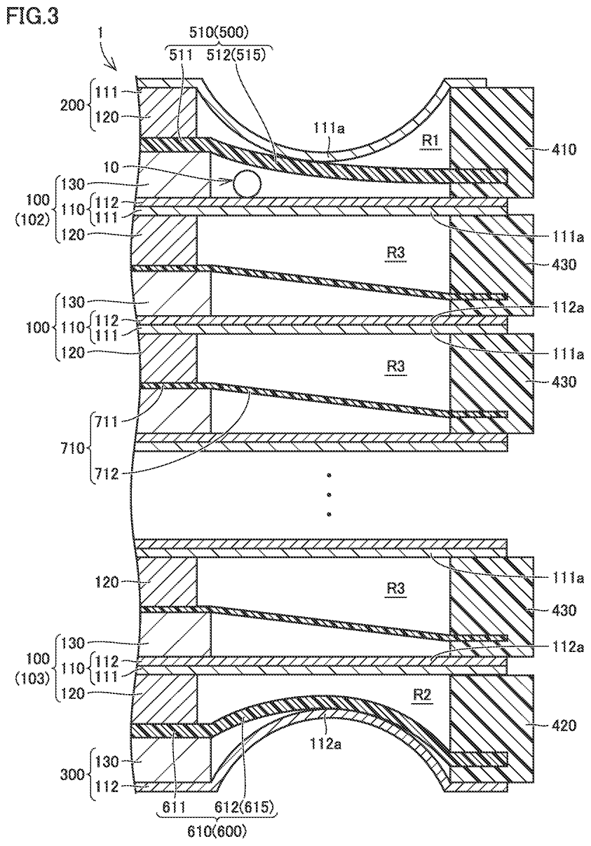

Next, with reference to FIG. 3, a power storage module 1 according to Second Embodiment of the present disclosure will be described. The below description of Second Embodiment only explains about the parts that are different from First Embodiment, and explanation of the same structure, action, and effect as in First Embodiment will not be repeated.

In the present embodiment, each of the thickness of first separator 510 and the thickness of second separator 610 is more than the thickness of inner separator 710. Moreover, first outer insulating part 515 is constituted solely of first peripheral part 512 which is thicker than inner peripheral part 712, and second outer insulating part 615 is constituted solely of second peripheral part 612 which is thicker than inner peripheral part 712.

### EXAMPLES

Next, examples of power storage module 1 will be described, along with Comparative Examples. Example 1-1 to Example 1-8 are examples of Second Embodiment, and Example 2-1 to Example 5-3 are examples of First Embodiment. In each of Examples and Comparative Examples, a power storage module having the below configuration was used.

Positive electrode current-collecting foil: Aluminum foil having a positive electrode provided on one side.

Positive electrode: Slurry of PVdF binder and electrically-conductive material in NMP or water solvent.

Negative electrode current-collecting foil: Copper foil having a negative electrode provided on one side.

Negative electrode: Slurry of SBR, CMC, and if needed electrically-conductive material, in water solvent.

Positive electrode active material layer: Li(NiₓMn_{y}Co_{z})O₂ and/or LiFePO₄, etc.

Negative electrode active material layer: Natural graphite and/or artificial graphite, etc.

Separator: Microporous polyolefin film (a film having a polyethylene monolayer and a ceramic layer).

First insulating film: LDPE (low-density polyethylene), HDPE (high-density polyethylene), PP (polypropylene), polyimide.

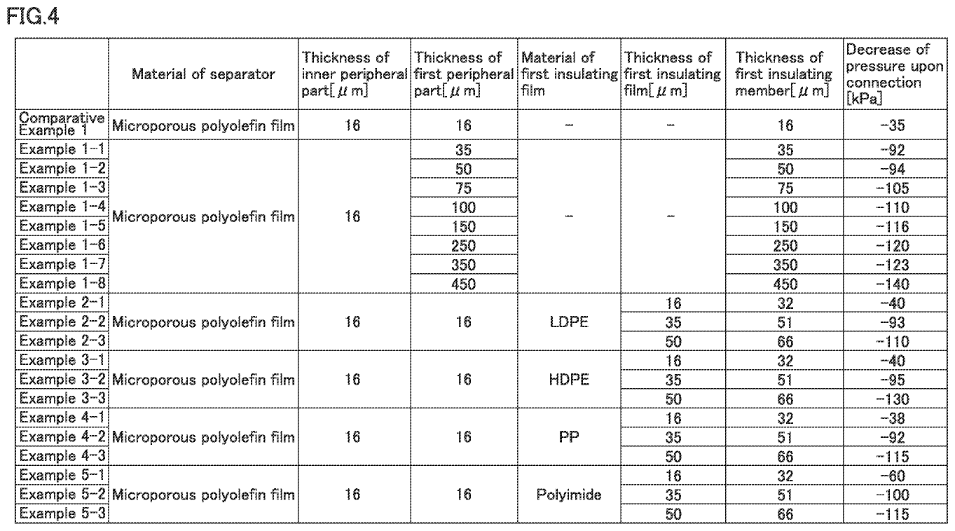

In each of Examples and Comparative Examples, five foreign objects 10 were placed inside power storage module 1, within first outer region R1 on the inside of first peripheral part 512 in the stacking direction, and, in that state, the pressure of first outer region R1 was reduced in the same environment as in the reduced-pressure sealing step performed during production of power storage module 1; while the resistance between outermost positive electrode 200 and bipolar electrode 102 was being measured, the decrease of pressure from atmospheric pressure (pressure difference from atmospheric pressure) was evaluated at the time when first outer insulating part 515 broke and thereby positive electrode current-collecting foil 111 of outermost positive electrode 200 was electrically connected with negative electrode current-collecting foil 112 of bipolar electrode 102. FIG. 4 is a table showing evaluation results of Examples and Comparative Examples. The foreign object was an L-shaped piece of metal (0.6 mm in the longitudinal direction, 0.4 mm in the widthwise direction). The covering rate at which negative-electrode-free portion 112a of bipolar electrode 102 was covered with first insulating film 520 was 95%.

Examples 1-1 to 1-8 in FIG. 4 show that, in the Examples where first outer insulating part 515 was constituted solely of first peripheral part 512, the decrease of pressure increased as the thickness of first peripheral part 512 increased.

In Examples 2-1 to 5-3, a separator having the same configuration as Comparative Example as well as first insulating film 520 having different thicknesses were used. These Examples show that, also in the Examples where first outer insulating part 515 was constituted of first peripheral part 512 and first insulating film 520, the decrease of pressure increased as the thickness of first outer insulating part 515 (the thickness of first insulating film 520) increased.

A person skilled in the art will appreciate that the above-described example embodiments and Examples are specific examples of the following aspects.

[Aspect 1]

A power storage module comprising:
a plurality of bipolar electrodes stacked on top of one another;
an outermost positive electrode located on one outer side of a set of the plurality of bipolar electrodes in a stacking direction of the plurality of bipolar electrodes;
an outermost negative electrode located on the other outer side of the set of the plurality of bipolar electrodes in the stacking direction;
a first sealing part that seals a first outer region in a state where pressure of the first outer region is below atmospheric pressure, the first outer region being formed between the outermost positive electrode and a bipolar electrode among the plurality of bipolar electrodes facing the outermost positive electrode;
a second sealing part that seals a second outer region in a state where pressure of the second outer region is below atmospheric pressure, the second outer region being formed between the outermost negative electrode and a bipolar electrode among the plurality of bipolar electrodes facing the outermost negative electrode;
an inner sealing part that seals an inner region in a state where pressure of the inner region is below atmospheric pressure, the inner region being formed between a pair of the bipolar electrodes that are adjacent to each other in the stacking direction;
a first insulating member that insulates the outermost positive electrode from the bipolar electrode among the plurality of bipolar electrodes facing the outermost positive electrode;
a second insulating member that insulates the outermost negative electrode from the bipolar electrode among the plurality of bipolar electrodes facing the outermost negative electrode; and
an inner insulating member that insulates a pair of the bipolar electrodes that are adjacent to each other in the stacking direction, from one another, where
each of the plurality of bipolar electrodes has:
   a current collector including a positive electrode current-collecting foil and a negative electrode current-collecting foil;
   a positive electrode active material layer provided on the positive electrode current-collecting foil of the current collector; and
   a negative electrode active material layer provided on the negative electrode current-collecting foil of the current collector,
the outermost positive electrode has:
   a positive electrode current-collecting foil; and
   a positive electrode active material layer provided on the positive electrode current-collecting foil,
the outermost negative electrode has:
   a negative electrode current-collecting foil; and
   a negative electrode active material layer provided on the negative electrode current-collecting foil,
at each of a periphery of the positive electrode current-collecting foil of the current collector and a periphery of the positive electrode current-collecting foil of the outermost positive electrode, a positive-electrode-free portion that is not covered with the positive electrode active material layer is formed,
at each of a periphery of the negative electrode current-collecting foil of the current collector and a periphery of the negative electrode current-collecting foil of the outermost negative electrode, a negative-electrode-free portion that faces the positive-electrode-free portion in the stacking direction and that is not covered with the negative electrode active material layer is formed,
a region between the positive-electrode-free portion of the outermost positive electrode and the negative-electrode-free portion facing the positive-electrode-free portion constitutes the first outer region,
a region between the negative-electrode-free portion of the outermost negative electrode and the positive-electrode-free portion facing the negative-electrode-free portion constitutes the second outer region,
a region between a pair of the bipolar electrodes that are adjacent to each other, specifically between the positive-electrode-free portion and the negative-electrode-free portion facing each other in the stacking direction, constitutes the inner region,
the first insulating member includes a first outer insulating part located in the first outer region,
the second insulating member includes a second outer insulating part located in the second outer region,
the inner insulating member includes an inner insulating part located in the inner region, and
each of a thickness of the first outer insulating part and a thickness of the second outer insulating part is more than a thickness of the inner insulating part.

In this power storage module, the positive-electrode-free portion of the outermost positive electrode and the negative-electrode-free portion of the outermost negative electrode deform inwardly in the stacking direction due to the low pressure of the first outer region, the second outer region, and the inner region below atmospheric pressure, but because each of the thickness of the first outer insulating part and the thickness of the second outer insulating part is more than the thickness of the inner insulating part, a foreign object such as a piece of metal, if it is present, in the first outer region, for example, is inhibited from penetrating through the first outer insulating part.

In addition, because the thickness of the inner insulating part is less than each of the thickness of the first outer insulating part and the thickness of the second outer insulating part, the inner region has enough space for holding gas that is produced during charging and discharging and, thereby, the pressure of the inner region is less likely to become high. This reduces breakage of the inner sealing part, and it also decreases the necessity for enlarging the electrode-free portions in the bipolar electrodes in an attempt to prevent the pressure of the inner region from rising too high, resulting in mitigating a decrease of energy density.

[Aspect 2]

The power storage module according to Aspect 1, wherein
the first insulating member includes a first separator that is interposed between the outermost positive electrode and the bipolar electrode among the plurality of bipolar electrodes facing the outermost positive electrode,
the first separator has:
   a first interposed part that is interposed between the positive electrode active material layer of the outermost positive electrode and the negative electrode active material layer of the bipolar electrode; and
   a first peripheral part that is connected with the first interposed part and located in the first outer region,
the first outer insulating part has:
   the first peripheral part; and
   a first insulating film that is a separate member from the first separator and that is located in the first outer region,
the second insulating member includes a second separator that is interposed between the outermost negative electrode and the bipolar electrode among the plurality of bipolar electrodes facing the outermost negative electrode, the second separator having the same thickness as the first separator,
the second separator has:
   a second interposed part that is interposed between the negative electrode active material layer of the outermost negative electrode and the positive electrode active material layer of the bipolar electrode; and
   a second peripheral part that is connected with the second interposed part and located in the second outer region,
the second outer insulating part has:
   the second peripheral part; and
   a second insulating film that is a separate member from the second separator and that is located in the second outer region,
the inner insulating member includes an inner separator that is interposed between a pair of the bipolar electrodes that are adjacent to each other in the stacking direction, the inner separator having the same thickness as the first separator,
the inner separator has:
   an inner interposed part that is interposed between the positive electrode active material layer of one bipolar electrode of the pair and the negative electrode active material layer of the other bipolar electrode of the pair; and
   an inner peripheral part that is connected with the inner interposed part and located in the inner region, and
the inner insulating part is constituted of the inner peripheral part.

In this aspect, the first separator, the second separator, and the inner separator have the same thickness, so the same separator can be used as them. Moreover, as compared to the case where each of the total thickness of the first separator and the total thickness of the second separator is more than the thickness of the inner separator, each of the thickness of the first interposed part and the thickness of the second interposed part is small.

[Aspect 3]

The power storage module according to Aspect 2, wherein
the first insulating film is located in the first outer region and on an inside of the first peripheral part in the stacking direction, and
the second insulating film is located in the second outer region and on an inside of the second peripheral part in the stacking direction.

This aspect can prevent displacement of the insulating films from occurring when the positive-electrode-free portion of the outermost positive electrode and the negative-electrode-free portion of the outermost negative electrode are deformed inwardly in the stacking direction. Moreover, as compared to the case where the insulating film is located on the outside of the periphery in the stacking direction within the outer region, breakage of the first peripheral part and the second peripheral part due to the above-described deformation of the positive-electrode-free portion of the outermost positive electrode and the negative-electrode-free portion of the outermost negative electrode is reduced.

[Aspect 4]

The power storage module according to Aspect 3, wherein
the first insulating film is made of the same material as a material of the first sealing part and integrally formed with the first sealing part, and
the second insulating film is made of the same material as a material of the second sealing part and integrally formed with the second sealing part.

In this aspect, displacement of the first insulating film within the first outer region and displacement of the second insulating film within the second outer region are reduced.

[Aspect 5]

The power storage module according to Aspect 1, wherein
the first insulating member includes a first separator that is interposed between the outermost positive electrode and the bipolar electrode among the plurality of bipolar electrodes facing the outermost positive electrode,
the first separator has:
   a first interposed part that is interposed between the positive electrode active material layer of the outermost positive electrode and the negative electrode active material layer of the bipolar electrode; and
   a first peripheral part that is connected with the first interposed part and located in the first outer region,
the first outer insulating part is constituted of the first peripheral part,
the second insulating member includes a second separator that is interposed between the outermost negative electrode and the bipolar electrode among the plurality of bipolar electrodes facing the outermost negative electrode, the second separator having the same thickness as the first separator,
the second separator has:
   a second interposed part that is interposed between the negative electrode active material layer of the outermost negative electrode and the positive electrode active material layer of the bipolar electrode; and
   a second peripheral part that is connected with the second interposed part and located in the second outer region,
the second outer insulating part is constituted of the second peripheral part,
the inner insulating member includes an inner separator that is located between a pair of the bipolar electrodes that are adjacent to each other in the stacking direction, the inner separator having a thickness less than a thickness of the first separator,
the inner separator has:
   an inner interposed part that is interposed between the positive electrode active material layer of one bipolar electrode of the pair and the negative electrode active material layer of the other bipolar electrode of the pair; and
   an inner peripheral part that is connected with the inner interposed part and located in the inner region, and
the inner insulating part is constituted of the inner peripheral part.

In this aspect, the same effect as exhibited by Aspect 1 can be obtained by only adjusting the thickness of the separators.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A power storage module comprising:
a plurality of bipolar electrodes stacked on top of one another;
an outermost positive electrode located on one outer side of a set of the plurality of bipolar electrodes in a stacking direction of the plurality of bipolar electrodes;
an outermost negative electrode located on the other outer side of the set of the plurality of bipolar electrodes in the stacking direction;
a first sealing part that seals a first outer region in a state where pressure of the first outer region is below atmospheric pressure, the first outer region being formed between the outermost positive electrode and a bipolar electrode among the plurality of bipolar electrodes facing the outermost positive electrode;
a second sealing part that seals a second outer region in a state where pressure of the second outer region is below atmospheric pressure, the second outer region being formed between the outermost negative electrode and a bipolar electrode among the plurality of bipolar electrodes facing the outermost negative electrode;
an inner sealing part that seals an inner region in a state where pressure of the inner region is below atmospheric pressure, the inner region being formed between a pair of the bipolar electrodes that are adjacent to each other in the stacking direction;
a first insulating member that insulates the outermost positive electrode from the bipolar electrode among the plurality of bipolar electrodes facing the outermost positive electrode;
a second insulating member that insulates the outermost negative electrode from the bipolar electrode among the plurality of bipolar electrodes facing the outermost negative electrode; and
an inner insulating member that insulates a pair of the bipolar electrodes that are adjacent to each other in the stacking direction, from one another, where
each of the plurality of bipolar electrodes has:
a current collector including a positive electrode current-collecting foil and a negative electrode current-collecting foil;
a positive electrode active material layer provided on the positive electrode current-collecting foil of the current collector; and
a negative electrode active material layer provided on the negative electrode current-collecting foil of the current collector,
the outermost positive electrode has:
a positive electrode current-collecting foil; and
a positive electrode active material layer provided on the positive electrode current-collecting foil,
the outermost negative electrode has:
a negative electrode current-collecting foil; and
a negative electrode active material layer provided on the negative electrode current-collecting foil,
at each of a periphery of the positive electrode current-collecting foil of the current collector and a periphery of the positive electrode current-collecting foil of the outermost positive electrode, a positive-electrode-free portion that is not covered with the positive electrode active material layer is formed,
at each of a periphery of the negative electrode current-collecting foil of the current collector and a periphery of the negative electrode current-collecting foil of the outermost negative electrode, a negative-electrode-free portion that faces the positive-electrode-free portion in the stacking direction and that is not covered with the negative electrode active material layer is formed,
a region between the positive-electrode-free portion of the outermost positive electrode and the negative-electrode-free portion facing the positive-electrode-free portion constitutes the first outer region,
a region between the negative-electrode-free portion of the outermost negative electrode and the positive-electrode-free portion facing the negative-electrode-free portion constitutes the second outer region,
a region between a pair of the bipolar electrodes that are adjacent to each other, specifically between the positive-electrode-free portion and the negative-electrode-free portion facing each other in the stacking direction, constitutes the inner region,
the first insulating member includes a first outer insulating part located in the first outer region,
the second insulating member includes a second outer insulating part located in the second outer region,
the inner insulating member includes an inner insulating part located in the inner region, and
each of a thickness of the first outer insulating part and a thickness of the second outer insulating part is more than a thickness of the inner insulating part.

2. The power storage module according to claim 1, wherein
the first insulating member includes a first separator that is interposed between the outermost positive electrode and the bipolar electrode among the plurality of bipolar electrodes facing the outermost positive electrode,
the first separator has:
a first interposed part that is interposed between the positive electrode active material layer of the outermost positive electrode and the negative electrode active material layer of the bipolar electrode; and
a first peripheral part that is connected with the first interposed part and located in the first outer region,
the first outer insulating part has:
the first peripheral part; and
a first insulating film that is a separate member from the first separator and that is located in the first outer region,
the second insulating member includes a second separator that is interposed between the outermost negative electrode and the bipolar electrode among the plurality of bipolar electrodes facing the outermost negative electrode, the second separator having the same thickness as the first separator,
the second separator has:
a second interposed part that is interposed between the negative electrode active material layer of the outermost negative electrode and the positive electrode active material layer of the bipolar electrode; and
a second peripheral part that is connected with the second interposed part and located in the second outer region,
the second outer insulating part has:
the second peripheral part; and
a second insulating film that is a separate member from the second separator and that is located in the second outer region,
the inner insulating member includes an inner separator that is interposed between a pair of the bipolar electrodes that are adjacent to each other in the stacking direction, the inner separator having the same thickness as the first separator,
the inner separator has:
an inner interposed part that is interposed between the positive electrode active material layer of one bipolar electrode of the pair and the negative electrode active material layer of the other bipolar electrode of the pair; and
an inner peripheral part that is connected with the inner interposed part and located in the inner region, and
the inner insulating part is constituted of the inner peripheral part.

3. The power storage module according to claim 2, wherein
the first insulating film is located in the first outer region and on an inside of the first peripheral part in the stacking direction, and
the second insulating film is located in the second outer region and on an inside of the second peripheral part in the stacking direction.

4. The power storage module according to claim 3, wherein
the first insulating film is made of the same material as a material of the first sealing part and integrally formed with the first sealing part, and
the second insulating film is made of the same material as a material of the second sealing part and integrally formed with the second sealing part.

5. The power storage module according to claim 1, wherein
the first insulating member includes a first separator that is interposed between the outermost positive electrode and the bipolar electrode among the plurality of bipolar electrodes facing the outermost positive electrode,
the first separator has:
a first interposed part that is interposed between the positive electrode active material layer of the outermost positive electrode and the negative electrode active material layer of the bipolar electrode; and
a first peripheral part that is connected with the first interposed part and located in the first outer region,
the first outer insulating part is constituted of the first peripheral part,
the second insulating member includes a second separator that is interposed between the outermost negative electrode and the bipolar electrode among the plurality of bipolar electrodes facing the outermost negative electrode, the second separator having the same thickness as the first separator,
the second separator has:
a second interposed part that is interposed between the negative electrode active material layer of the outermost negative electrode and the positive electrode active material layer of the bipolar electrode; and
a second peripheral part that is connected with the second interposed part and located in the second outer region,
the second outer insulating part is constituted of the second peripheral part,
the inner insulating member includes an inner separator that is located between a pair of the bipolar electrodes that are adjacent to each other in the stacking direction, the inner separator having a thickness less than a thickness of the first separator,
the inner separator has:
an inner interposed part that is interposed between the positive electrode active material layer of one bipolar electrode of the pair and the negative electrode active material layer of the other bipolar electrode of the pair; and
an inner peripheral part that is connected with the inner interposed part and located in the inner region, and
the inner insulating part is constituted of the inner peripheral part.
